(19) United States
(12) Patent Application Publication
(10) Pub. No.: US 2010/0155441 A1
(43) Pub. Date: Jun. 24, 2010

(54) BAND UNIT FOR A HOLDING DEVICE AND HOLDING DEVICE

(75) Inventors: Ralf Gaudig, Ruesselsheim (DE); Klaus Kuhlmann, Nauheim (DE); Werner Berhard, Nauheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/645,128

(22) Filed: Dec. 22, 2009

(30) Foreign Application Priority Data
Dec. 22, 2008 (DE) 102008064459.5

(51) Int. Cl. B60R 7/00; A44B 99/00

(52) U.S. Cl. 224/282; 24/484

(57) ABSTRACT

A motor vehicle is provided with at least one holding device, a holding device with at least one band unit and a band unit for a holding device used to clamp objects in place, which includes, but is not limited to an oblong band element with two band ends. The band element at least partially encompasses a flexible band material and the hinged units are secured to the band ends in order to realize an arrangement in which the band unit is hinged to the holding device.

### CROSS-REFERENCE TO RELATED APPLICATION

This application claims priority to German Patent Application No. 102008064459.5, filed Dec. 22, 2008, which is incorporated herein by reference in its entirety.

### TECHNICAL FIELD

The invention relates to a band unit for a holding device used to clamp objects in place. The invention further relates to a holding device for a motor vehicle, in particular for a motor vehicle passenger compartment, to hold objects. In addition, the invention relates to a motor vehicle with a holding device.

### BACKGROUND

Known in the art are various holding devices for clamping objects in place while traveling in a motor vehicle. Known from US 2008/0001423 A1 is a bistable band whose ends are directly secured to a motor vehicle structure, so that the ends act as a hinged joint.

At least one object of the present invention is to provide a band unit that enables an optimized attachment to a motor vehicle structure. Another object of the present invention in particular is to provide a holding device for a motor vehicle designed for an optimized holding of objects. Yet another object of the present invention is to provide a motor vehicle with a passenger compartment that exhibits an optimized holding device. In addition, other objects, desirable features, and characteristics will become apparent from the subsequent summary and detailed description, and the appended claims, taken in conjunction with the accompanying drawings and this background.

### SUMMARY

Included is the technical instruction that, in a band unit for a holding device used to clamp objects in place, comprising an oblong band element with two band ends, wherein the band element at least partially encompasses a flexible band material, hinged units are secured to the band ends to realize an arrangement in which the band unit is hinged to a holding device. In one embodiment, the band unit is designed as a bistable band unit, wherein in particular the band element is bistable in design. The band element preferably exhibits two ends, which are thinner or tapered by comparison to the remaining material. For example, the thinning material is deigned in such a way that a hinged unit can be secured to the band end in such a way that the surfaces of the band element and hinged unit essentially abut in a flush manner.

One embodiment of the present invention provides that the hinged units exhibit a sleeve-like connecting element, with which the band unit can be hinged. The connecting element can have a different material than the band element. The connecting element preferably envelops the band element from several directions, thereby realizing a kind of mount for the band end. As a result, the connecting element provides for the protection of the band end, as well as a simple attachment for hinging purposes. For example, the connecting element is designed as a bracket or sleeve.

Another embodiment of the present invention provides that the hinged units are spray coated at least partially by the band material, thereby forming a solid unit of hinged units and band element. To ensure an optimized coupling of the hinged unit to the band element, the hinged unit is at least partially spray coated, preferably with a band material. In this way, in effect separate components can be optimally integrated, yielding a solid band unit. The band unit is hence designed as a kind of composite material.

Incorporated is the technical instruction that, in a holding device for a motor vehicle, in particular for a motor vehicle passenger compartment, used to hold objects, comprising a motor vehicle structure, it is provided that at least one band unit be hinged to the motor vehicle structure. The motor vehicle structure can be the housing of a stowage compartment or frame. For example, the motor vehicle structure can be any section of the inner skin of a motor vehicle to which a band unit can be secured. The motor vehicle structure here acts as a supporting structure for holding the band unit, and can additionally form a floor to support one of the objects accommodated by the band unit. The ends of the band unit are preferably spaced apart in such a way that the distance between the ends is lower than one length of the band element. This arrangement is advantageous to form a bistable band element.

For this reason, one embodiment of the present invention provides that the motor vehicle structure exhibits a holding section that interacts with the band element, which exhibits two mounting locations per band unit spaced apart from each other for holding the band unit.

Another preferred embodiment of the present invention provides that a distance between the two mounting locations be less than one length of the band unit, so that a bistable band unit able to assume two stable positions can be joined with the mounting locations. The distance is here dimensioned in such a way as to create a retaining area optimized for the application between the band element and motor vehicle structure. The flexible design of the band element makes it possible to clamp an object accommodated in the retaining area.

Yet another preferred embodiment of the present invention provides that the band unit is nestled against the holding section in a first stable position, and forms a retaining area between the band unit and holding section in a second stable position, in which objects can be clamped in place. The holding section is preferably concave or convex in design. The band element nestles against the corresponding holding section in a first position, and does not project from the latter. The band element is correspondingly curved in the case of a convex or concave holding section. The band element forms a roughly oval retaining area with the allocated holding section in the second position, in which objects can be accommodated.

Yet another preferred embodiment of the present invention provides for the use of several band units. The band units can be arranged on a shared side of the holding structure, or on different sides. In addition, the band units can be offset relative to each other and/or overlap.

Yet another embodiment of the present invention provides that the mounting locations are designed as hinged mounting locations. The mounting locations here encompass a separate hinged unit, with which the band element is joined with the motor vehicle structure. In this way, the hinge can be changed out separately from the band element in cases of wear.

Another embodiment of the present invention provides that at least two band units are allocated to a shared mounting location. This makes it possible to effectively reduce the number of mounting locations. This coupling can be used to form several retaining areas with the band units.

Encompassed is the technical instruction wherein, in a motor vehicle with a passenger compartment, in particular a passenger car, it is provided that the passenger compartment accommodates at least one holding device according to the invention. Several holding devices can be provided. For example, the holding devices can be secured in a glove compartment, a center console or to any locations of the passenger compartment paneling.

Other measures that improve the invention are indicated in the claims and subclaims, or may be gleaned from the following description of exemplary embodiments of the invention, which are shown diagrammatically on the figures. Uniform reference numbers are here used for identical or similar components or features. Features or components of different embodiments can be combined so as to yield additional embodiments. All features and/or advantages arising from the claims of the specification or drawings, including structural details, spatial arrangement and procedural steps, can also be essential to the invention taken in and of themselves or in various combinations.

### BRIEF DESCRIPTION OF THE DRAWINGS

The present invention will hereinafter be described in conjunction with the following drawing figures, wherein like numerals denote like elements, and:

FIG. 1 is a diagrammatic, perspective view of a stowage compartment incorporated in a center console of a motor vehicle, with two holding devices each having one band unit;

FIG. 2 is a diagrammatic view of the stowage compartment according to FIG. 1, with the band units in a second position;

FIG. 3 is a diagrammatic, perspective view of another embodiment of the center console with stowage compartment and holding device;

FIG. 4 is a diagrammatic view of the stowage compartment according to FIG. 3 with the band units in a second position;

FIG. 5 is a diagrammatic, top view of a holding device with the band unit in a second position;

FIG. 6 is a diagrammatic view through the holding device according to FIG. 5 along intersecting line A-A;

FIG. 7 is a diagrammatic, exploded view of the connection between a band unit and a motor vehicle structure; and on

FIG. 8 is a diagrammatic, exploded view of a section of a band unit.

### DETAILED DESCRIPTION

The following detailed description is merely exemplary in nature and is not intended to limit application and uses. Furthermore, there is no intention to be bound by any theory presented in the preceding background or summary or the following detailed description.

FIG. 1 shows a diagrammatic, perspective view of a stowage compartment 2 with two holding devices 3 each having a band unit 4, incorporated into a center console 1 of a motor vehicle. The stowage compartment 2 exhibits a housing that defines a stowage area. The housing accommodates two opposing holding devices 3 spaced apart from each other. The holding device 3 encompasses a motor vehicle structure 5, to which the band unit 4 is secured. Any motor vehicle side structure in conjunction with an embodiment of the invention is here referred to as a motor vehicle structure. The structure is rigidly secured to the vehicle in one configuration. In other configurations, the structure is movably mounted in the vehicle. The motor vehicle structure 5 is here designed as a curved web with a convex hollow in a center console. The band unit 4 nestles against the convex hollow in the position depicted. In these first positions, the band unit 4 is situated in a first stable location.

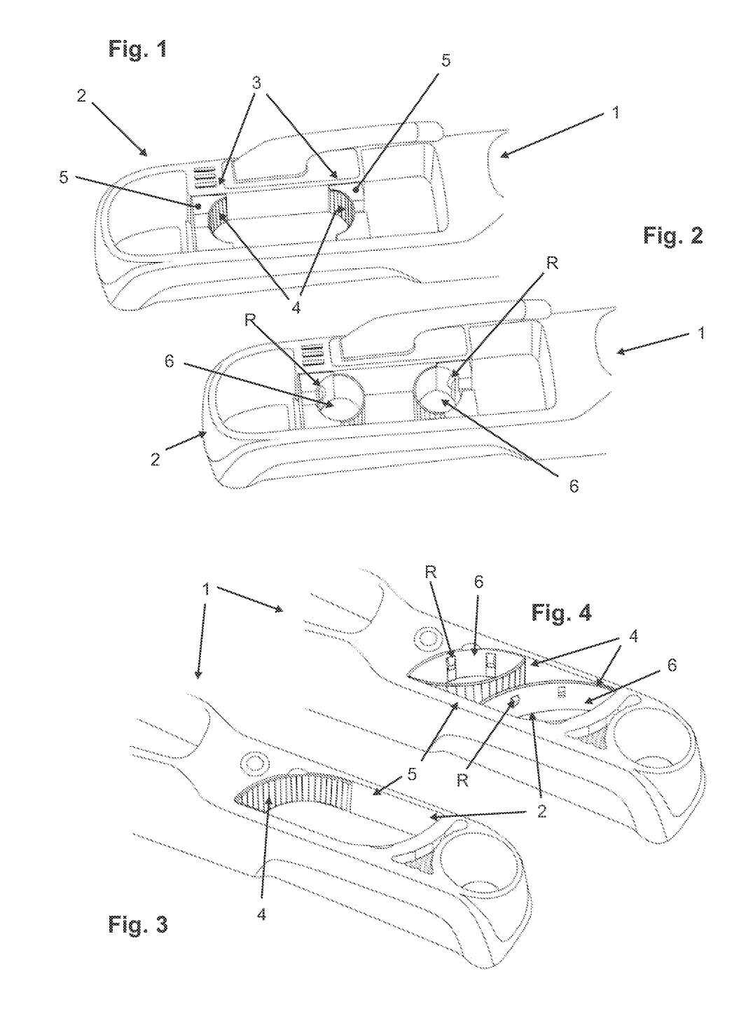

FIG. 2 shows a diagrammatic view of the stowage compartment 2 according to FIG. 1 with the band units 4 in a second position. The band unit 4 is designed as a bistable element, and is in the arrangement according to FIG. 2 is situated in the second stable location. In conjunction with the convex or concave web, the band unit 4 forms a roughly oval or circular retaining area 6 in a top view. For example, this retaining area 6 can be used for holding cups or mugs. Latching elements can be provided on the band elements 4 and/or motor vehicle structure 5, as depicted.

FIG. 3 shows a diagrammatic, perspective view of another embodiment of the center console 1 with stowage compartment 2 and holding devices 3. In the exemplary embodiment shown on FIG. 3, one housing wall of the housing constitutes the motor vehicle structure 5 to which the band unit 4 is secured. The stowage compartment 2 and holding devices 3 are hence integrated in design.

FIG. 4 shows a diagrammatic view of the stowage compartment 2 according to FIG. 3 with the band units 4 in a second position. Similarly to FIG. 2, FIG. 4 shows the band units 4 in a second, stable position. The retaining area 6 is roughly oval in shape based on the top view on FIG. 4. As evident from FIG. 4, the depicted band elements 4 and motor vehicle structure 5 exhibit latching elements R.

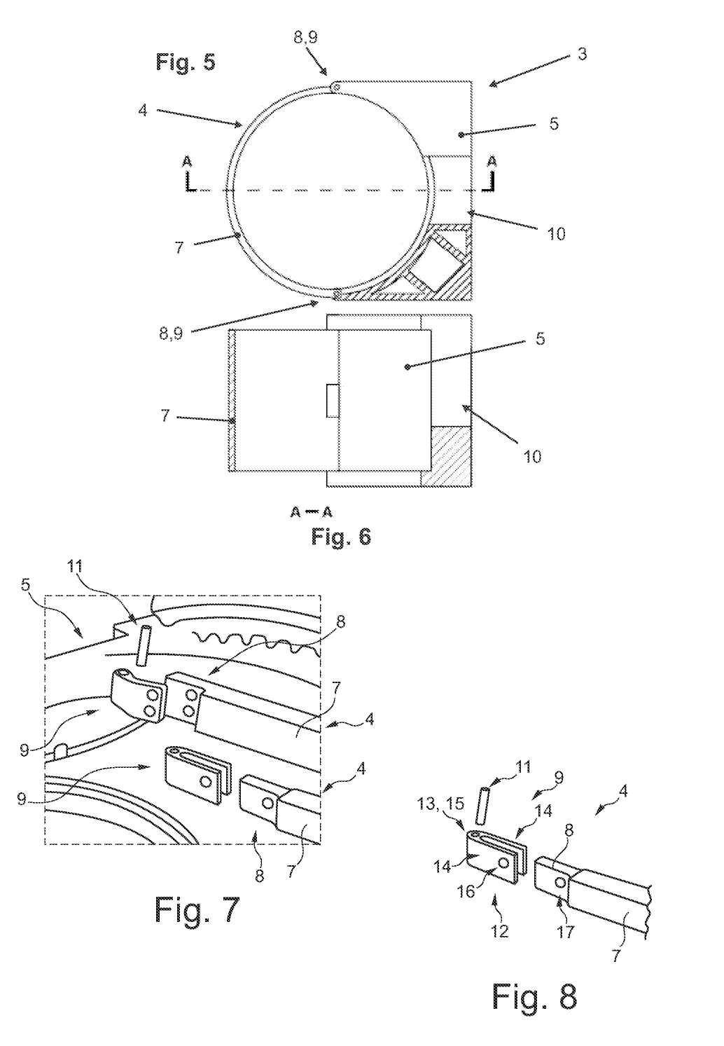

FIG. 5 shows a diagrammatic top view of a holding device 3 with the band unit 4 in a second position. In the second position, the band unit 4 forms the retaining area 6 in conjunction with the motor vehicle structure 5. The retaining area 6 is roughly circular in the top view. The depicted motor vehicle structure 5 is designed as a web with a concavely curved hollow, similarly to FIG. 2. The holding device 3 further encompasses the band unit 4, which comprises a band element 7 with two band ends 8, and a hinged unit 9 at each band end 8. The band unit 4 of the motor vehicle structure 5 is hinged via the hinged unit 9. In order to move the band element 7 from a first stable position into a second stable position, a gripping option 10 is incorporated in the motor vehicle structure 5.

FIG. 6 shows a diagrammatic, sectional view through the holding device 3 according to FIG. 5, along the intersecting line A-A.

FIG. 7 shows a diagrammatic, exploded view of the connection between a band unit 4 and motor vehicle structure 5. Two different embodiments of band units 4 are shown. The band units 4 each encompass a band element 7 and hinged unit 9, which is arranged at one band end 8. In order to enable the best possible connection, the band element 7 is thinned or tapered at the band end 8. The taper can be unilateral as depicted in the upper exemplary embodiment, or bilateral as shown in the lower exemplary embodiment. The type of taper depends on the kind of hinged unit 9. The hinged unit 9 is unilaterally secured to the band element 7 in the upper exemplary embodiment, and the hinged unit 9 is bilaterally secured to the band element in the lower exemplary embodiment, thereby encompassing the band end 8. The hinged units 9 are each hinged with the motor vehicle structure 5 by means of (rotating) journals or rotating axes 11.

FIG. 8 shows a diagrammatic, exploded view of a section of a band unit 4. The band unit 4 encompasses the band element 7 and hinged unit 9, which is arranged at a tapered or thinned band end 8. The hinged unit 9 encompasses a connecting element designed as a roughly U-shaped profile 12, wherein a receptacle 15 for the rotating journals 12 is provided in a connecting site 13 of the two legs 14 of the profile 12. A through hole 16 runs transversely through the two legs, and can incorporate a connecting element for joining the hinged unit 4 with the band end 8. The band element 7 provides a corresponding through hole 17.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A band unit for a holding device used to clamp objects in place, comprising:
an oblong band element with at least two band ends;
a flexible band material that is at least partially encompassed by the oblong band element; and
hinged units are secured to the at least two band ends to realize an arrangement in which the band unit is hinged to the holding device.

2. The band unit according to claim 1, further comprising a connecting element of the hinged units with which the band unit can be hinged.

3. The band unit according to claim 1, wherein the hinged units are at least partially spray coated with the flexible band material and yield a solid unit comprising the hinged units and the oblong band element.

4. A holding device for a motor vehicle for holding objects, comprising:
a motor vehicle structure; and
a band unit hinged to the motor vehicle structure, the band unit comprising:
an oblong band element with at least two band ends;
a flexible band material that is at least partially encompassed by the oblong band element; and
hinged units secured to the at least two band ends to realize an arrangement in which the band unit is hinged to the holding device.

5. The holding device according to claim 4, wherein the motor vehicle structure comprises:
a holding section that interacts with the oblong band element; and
two mounting locations per the band unit spaced apart from each other for holding the band unit.

6. The holding device according to claim 5, wherein a distance between the two mounting locations is less than one length of the band unit, so that a bistable band unit can be joined with the two mounting locations.

7. The holding device according to claim 5, wherein the band unit is nestled against the holding section in a first stable position, and forms a retaining area between the band unit and the holding section in a second stable position, in which objects can be clamped in place.

8. The holding device according to claim 4, further comprising a plurality of band units.

9. The holding device according to claim 5, wherein the two mounting locations are hinged mounting locations.

10. The holding device according to claim 4, wherein at least two band units are allocated to a shared mounting location.

11. A motor vehicle, comprising:
a passenger compartment;
a holding device incorporated with the passenger compartment, the holding device comprising:
a motor vehicle structure;
a band unit hinged to the motor vehicle structure, the band unit comprising:
an oblong band element with at least two band ends;
a flexible band material that is at least partially encompassed by the oblong band element; and
hinged units secured to the at least two band ends to realize an arrangement in which the band unit is hinged to the holding device.

12. The motor vehicle according to claim 11, wherein the motor vehicle structure comprises:
a holding section that interacts with the oblong band element; and
two mounting locations per the band unit spaced apart from each other for holding the band unit.

13. The motor vehicle according to claim 12, wherein a distance between the two mounting locations is less than one length of the band unit, so that a bistable band unit can be joined with the two mounting locations.

14. The motor vehicle according to claim 12, wherein the band unit is nestled against the holding section in a first stable position, and forms a retaining area between the band unit and the holding section in a second stable position, in which objects can be clamped in place.

15. The motor vehicle according to claim 11, further comprising a plurality of band units.

16. The motor vehicle according to claim 12, wherein the two mounting locations are hinged mounting locations.

17. The motor vehicle according to claim 11, wherein at least two band units are allocated to a shared mounting location.
